(19) United States
(12) Patent Application Publication
(10) Pub. No.: US 2026/0147659 A1
(43) Pub. Date: May 28, 2026

(54) CALCULATION APPARATUS

(71) Applicant: NEC Corporation, Tokyo (JP)

(72) Inventor: Masanao NATSUMEDA, Tokyo (JP)

(73) Assignee: NEC Corporation, Tokyo (JP)

(21) Appl. No.: 19/386,434

(22) Filed: Nov. 12, 2025

(30) Foreign Application Priority Data
Nov. 27, 2024 (JP) 2024-206114

(51) Int. Cl. G06F 11/07

(52) U.S. Cl. CPC G06F 11/079; G06F 11/0706

(57) ABSTRACT

A calculation apparatus includes: a calculation result acquiring unit that acquires a result of calculation of an anomaly degree using time-series log data including log data within a predetermined time width and time-series numerical data representing measurement values within the predetermined time width; an edition anomaly degree acquiring unit that acquires an edition anomaly degree, which is an anomaly degree at time of editing, by using the time-series numerical data at time of calculating the anomaly degree and edition log data obtained by editing part of the log data included by the time-series log data; and a contribution degree calculating unit that calculates a contribution degree indicating an extent to which an event corresponding to the edited log data has contributed to an anomaly by using the anomaly degree and the edition anomaly degree.

### INCORPORATION BY REFERENCE

This application is based upon and claims the benefit of priority from Japanese patent application No. 2024-206114, filed on November 27, 2024, the disclosure of which is incorporated herein in its entirety by reference.

### TECHNICAL FIELD

The present disclosure relates to a calculation apparatus, a calculation method, and a recording medium.

### BACKGROUND ART

Detection of the state of a target such as an information processing system may be performed using both numerical data measured by a sensor or the like and text data such as a system log.

For example, Patent Literature 1 discloses an anomaly detection method using a machine learning model considering the association between numerical data and text data. According to Patent Literature 1, in the anomaly detection method, in response to inputting log data, which is text data, and numerical data into a learned model, a feature vector including information representing the mutual directional dependency between the log data and the numerical data is generated. After that, in the anomaly detection method, anomaly detection is performed in accordance with the generated feature vector, the range of a planar space set at the time of learning, and so forth. Further, Patent Literature 1 discloses performing anomaly detection in accordance with, for example, the error between a performance prediction value output by inputting the log data and the numerical data into a learning model and the acquired performance data.

Further, a related technique is shown by Patent Literature 2, for example. Patent Literature 2 discloses a method for identifying numerical data contributing to an anomaly degree. According to Patent Literature 2, the method includes an influence degree calculation step of calculating a drift amount indicating the difference in distributions of anomaly degrees between a first evaluation period and a second evaluation period and calculating an influence degree indicating the extent of the influence based on the drift amount, and a factor identification step of identifying the factor of a prediction error based on the influence degree.

Patent Literature 1: WO2023/148843

Patent Literature 2: Japanese Unexamined Patent Application Publication No. JP-A 2024-028148

### SUMMARY

At the time of performing anomaly detection using the technique as described in Patent Literature 1, there may be a case where it is required to identify numerical data or text data contributing to an anomaly. However, with the technique described in Patent Literature 1, it is difficult to identify numerical data or text data contributing to an anomaly. Further, even when employing the technique as described in Patent Literature 2, it is difficult to grasp the contribution degree in text data while it is possible to grasp the contribution degree in numerical data. Thus, at the time of performing anomaly detection using numerical data and text data, there is an issue that it may be difficult to appropriately identify data contributing to an anomaly.

Accordingly, an object of the present disclosure is to provide a calculation apparatus, calculation method, and recording medium that can solve the abovementioned issue.

In order to achieve the object, a calculation apparatus according to the present disclosure includes: a calculation result acquiring unit that acquires a result of calculation of an anomaly degree using time-series log data including log data within a predetermined time width and time-series numerical data representing measurement values within the predetermined time width; an edition anomaly degree acquiring unit that acquires an edition anomaly degree, which is an anomaly degree at time of editing, by using the time-series numerical data at time of calculating the anomaly degree and edition log data obtained by editing part of the log data included by the time-series log data; and a contribution degree calculating unit that calculates a contribution degree indicating an extent to which an event corresponding to the edited log data has contributed to an anomaly by using the anomaly degree and the edition anomaly degree.

Further, a calculation method according to the present disclosure is a calculation method by an information processing apparatus, and the calculation method includes: acquiring a result of calculation of an anomaly degree using time-series log data including log data within a predetermined time width and time-series numerical data representing measurement values within the predetermined time width; acquiring an edition anomaly degree, which is an anomaly degree at time of editing, by using the time-series numerical data at time of calculating the anomaly degree and edition log data obtained by editing part of the log data included by the time-series log data; and calculating a contribution degree indicating an extent to which an event corresponding to the edited log data has contributed to an anomaly by using the anomaly degree and the edition anomaly degree.

Further, a recording medium according to the present disclosure is a non-transitory computer-readable recording medium with a program recorded thereon, and the program includes instructions for causing an information processing apparatus to enable processes to: acquire a result of calculation of an anomaly degree using time-series log data including log data within a predetermined time width and time-series numerical data representing measurement values within the predetermined time width; acquire an edition anomaly degree, which is an anomaly degree at time of editing, by using the time-series numerical data at time of calculating the anomaly degree and edition log data obtained by editing part of the log data included by the time-series log data; and calculate a contribution degree indicating an extent to which an event corresponding to the edited log data has contributed to an anomaly by using the anomaly degree and the edition anomaly degree.

With the configurations as described above, at the time of performing anomaly detection using numerical data and text data, it is possible to appropriately identify data contributing to an anomaly.

### BRIEF DESCRIPTION OF THE DRAWINGS

FIG. 1 is a diagram showing an operation overview of a calculation system according to the present disclosure;

FIG. 2 is a diagram showing a configuration example of the calculation system;

FIG. 3 is a block diagram showing a configuration example of a calculation apparatus;

FIG. 4 is a diagram for describing a processing example of an edition candidate extracting unit;

FIG. 5 is a diagram for describing a processing example of an edition anomaly degree acquiring unit;

FIG. 6 is a flowchart showing an operation example of the calculation apparatus;

FIG. 7 is a diagram for describing a calculation example of a contribution degree;

FIG. 8 is a diagram for describing a calculation example of a contribution degree;

FIG. 9 is a block diagram showing another configuration example of the calculation apparatus;

FIG. 10 is a block diagram showing a hardware configuration example of a calculation apparatus in a second example embodiment of the present disclosure; and

FIG. 11 is a block diagram showing a configuration example of the calculation apparatus.

### EXAMPLE EMBODIMENT

### First Example Embodiment

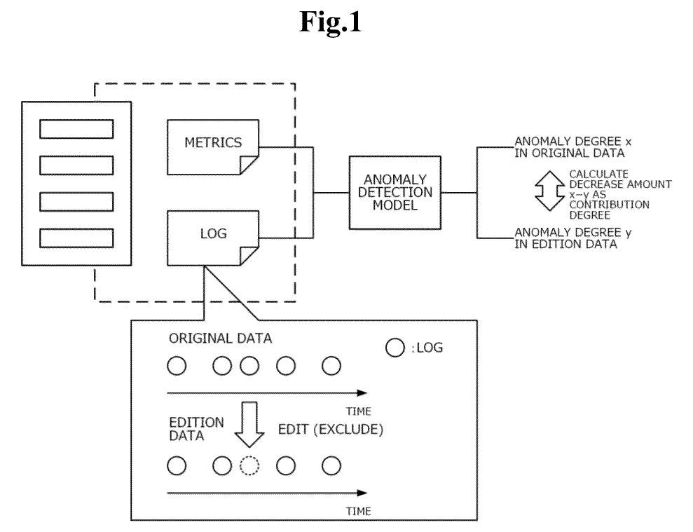

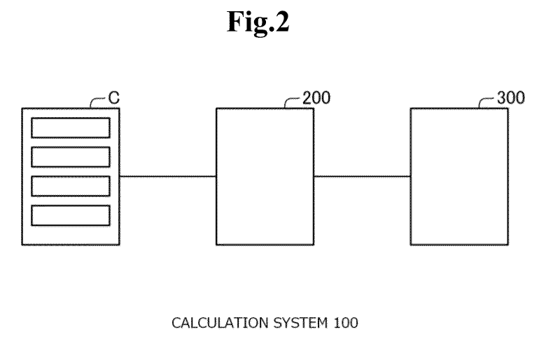

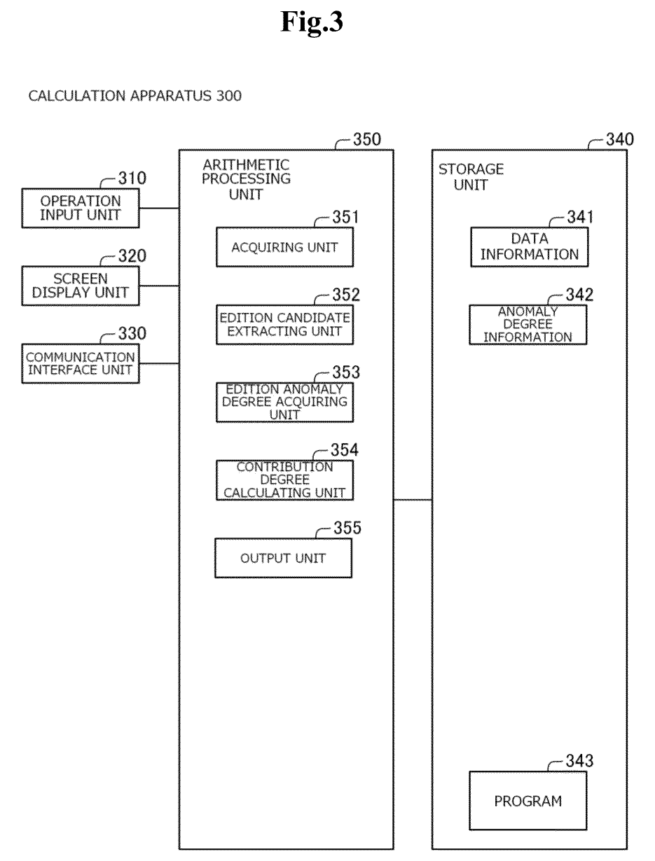

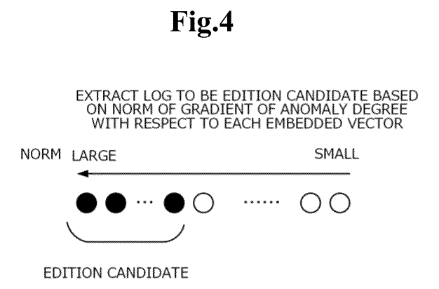

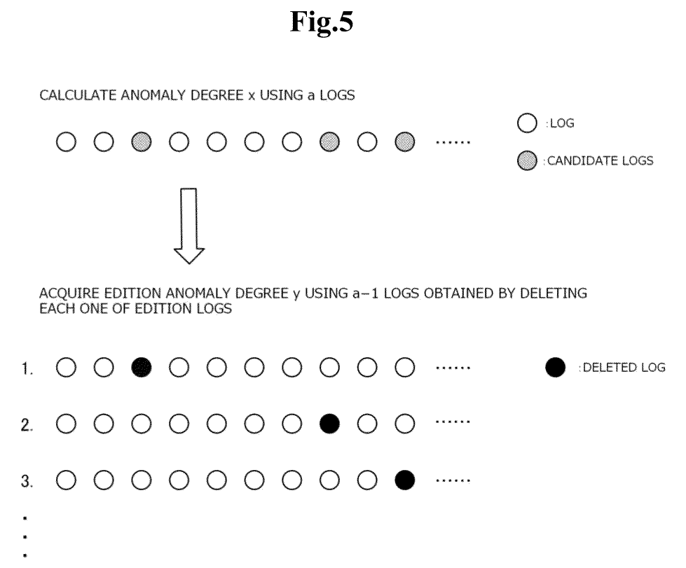

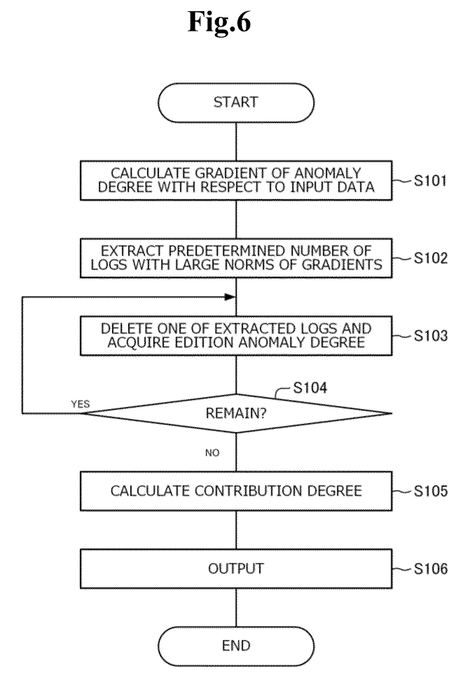

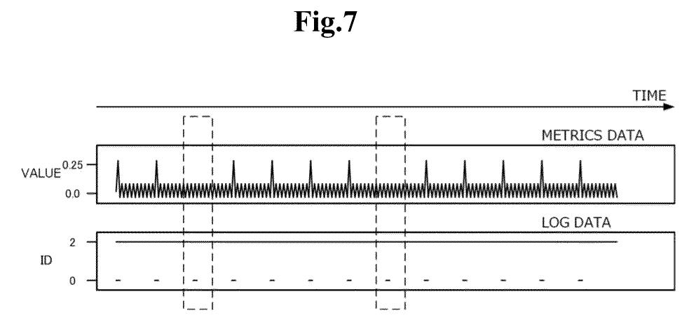

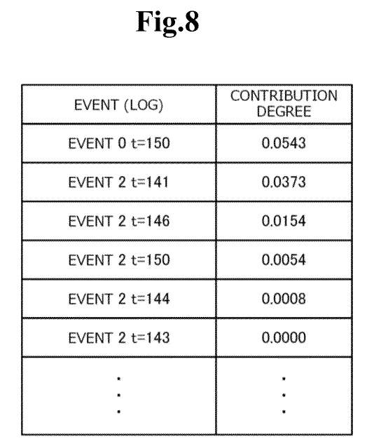

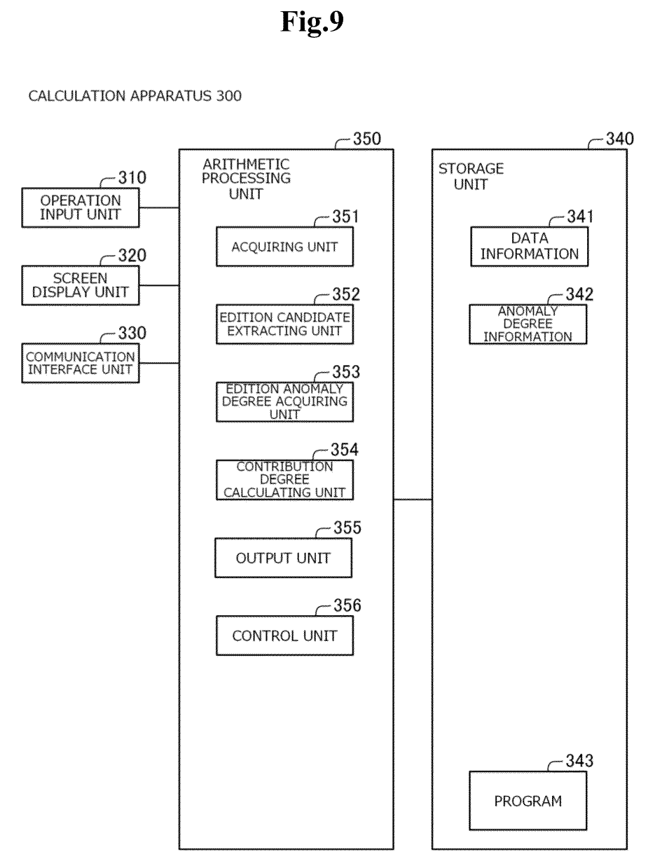

A configuration example of a calculation system 100 according to the present disclosure will be described with reference to FIGS. 1 to 9. FIG. 1 is a diagram showing an operation overview of the calculation system 100. FIG. 2 is a diagram showing a configuration example of the calculation system 100. FIG. 3 is a block diagram showing a configuration example of a calculation apparatus 300. FIG. 4 is a diagram for describing a processing example of an edition candidate extracting unit 352. FIG. 5 is a diagram for describing a processing example of an edition anomaly degree acquiring unit 353. FIG. 6 is a flowchart showing an operation example of the calculation device 300. FIGS. 7 and 8 are diagrams for describing a contribution degree calculation example. FIG. 9 is a block diagram showing another configuration example of the calculation apparatus 300. In the present disclosure, the drawings may be associated with one or more example embodiments.

In the present disclosure, the calculation system 100 will be described that calculates, according to the result of calculation of an anomaly degree using log data, which is text data, and numerical data, a contribution degree (score) indicating an extent to which at least the log data among the log data and the numerical data has contributed to an anomaly. For example, the calculation system 100 acquires the result of calculation of an anomaly degree using time-series log data composed of log data corresponding to the respective events having occurred in a target within a predetermined time width, and time-series numerical data representing measurement values corresponding to the predetermined time width among time-series measurement values that can be acquired by measuring the target. Moreover, the calculation system 100 acquires an edition anomaly degree, which is an anomaly degree at the time of edition, by using time-series numerical data at the time when the anomaly degree has been calculated and edition log data obtained by editing part of the log data included in the time-series log data. That is to say, the calculation system 100 fixes the time-series numerical data, and then edits the time-series log data and acquires the anomaly degree again, thereby acquiring the edition anomaly degree. After that, by using the anomaly degree and the edition anomaly degree, the calculation system 100 calculates a contribution degree (score) indicating an extent to which an event corresponding to the edited log data has contributed to the anomaly. For example, the calculation system 100 can calculate the contribution degree by performing a subtraction process of subtracting the edition anomaly degree from the anomaly degree.

FIG. 1 shows an operation overview of the calculation system 100. In the case of FIG. 1, the calculation system 100 performs contribution degree calculation by calculating an edition anomaly degree by using edition log data obtained by deleting one of the log data included by the time-series log data. For example, by calculating the contribution degree while changing log data to be deleted, the calculation system 100 can calculate a contribution degree indicating an extent to which an event corresponding to each of the log data included by the time-series log data has contributed to the anomaly. As will be described later, the calculation system 100 may be configured to identify log data to be an edition candidate according to any condition or the like, and to perform edition such as deletion on the identified log data.

In the present disclosure, the calculation system 100 acquires log data and numerical data from a detection target whose state is to be detected, and thereby acquires an anomaly degree. Here, the detection target is, for example, an information processing system such as a server apparatus. The detection target is not limited to an information processing system, and may be any entity, including plants such as a manufacturing factory and a processing facility. Moreover, the log data is, for example, text data corresponding to a time point and represents the processing content of an event and the like executed by the information processing system. The log data may be, for example, system logs or the like, and may be any other text data representing the processing content derived from the operation of equipment or facilities constituting the plant. In the present disclosure, it is assumed that the log data can be grouped based on similarities such as event types, and can be transformed into an embedded vector for each group. In other words, the log data can be transformed into embedded vectors according to the types of corresponding events or the like. The transformation into embedded vectors may be performed by any method. Moreover, the numerical data is numerical sequence data represented by numerical values such as the CPU (Central Processing Unit) use rate, memory use rate, disk access frequency, number of input/output packets, input/output packet rate, and power consumption values of the respective information processing apparatuses configuring the information processing system. The numerical data may constitute at least part of the data illustrated above. Furthermore, the numerical data may also be numerical values such as temperature, pressure, flow rate, power consumption value, supply quantity of raw material, and remaining quantity within a plant.

Further, the anomaly degree can represent a value corresponding to the state of the detection target. For example, the anomaly degree may represent that as the value is larger, a probability that the state of the detection target is anomalous is higher. The anomaly degree may also be a value corresponding to a precursor or likelihood of a failure. For example, the calculation system 100 can calculate the anomaly degree based on the result of inputting time-series log data and time-series numerical data into a learned model having leaned in advance. As an example, the calculation system 100 may calculate the anomaly degree using a feature vector that can be acquired in response to inputting time-series log data and time-series numerical data into a learned model having learned by the method as described in Patent Literature 1. The calculation system 100 may calculate the anomaly degree by any method, in addition to the method as described in Patent Literature 1. For example, the calculation system 100 may calculate the anomaly degree in accordance with inputting time-series log data and time-series numerical data into a learned model that calculates a reconstruction error. In other words, the calculation system 100 may calculate the anomaly degree by inputting time-series log data and time-series numerical data into a learned model to obtain an output value, then performing restoration of the output value, and checking the difference between the restored value and the original value. The calculation system 100 may calculate the anomaly degree by any method other than the methods as illustrated above.

FIG. 2 shows an example of a configuration included by the calculation system 100. Referring to FIG. 2, the calculation system 100 has a target C that is a detection target such as a server apparatus, a detection apparatus 200 that calculates an anomaly degree and detects an anomaly, and a calculation apparatus 300 that calculates a contribution degree using the result of calculation of the anomaly degree by the detection apparatus 200. As shown in FIG. 1, the target C and the detection apparatus 200 are connected so as to be able to communicate with each other. Further, the detection apparatus 200 and the calculation apparatus 300 are connected so as to be able to communicate with each other.

The configuration of the calculation system 100 is not limited to the case illustrated in FIG. 2. For example, the calculation system 100 may be configured with the target C and an information processing apparatus that includes both a function as the detection apparatus 200 and a function as the calculation device 300. Moreover, the calculation system 100 may include a plurality of targets C or the like.

The detection apparatus 200 is an information processing apparatus that performs calculation of an anomaly degree using log data and numerical data obtained from the target C. For example, the detection apparatus 200 calculates an anomaly degree in accordance with the result of inputting time-series log data including log data within a predetermined time width and time-series numerical data representing measurement values corresponding to the predetermined time width, into a learned model having learned in advance. Moreover, the detection apparatus 200 can perform detection of an anomaly using the calculated anomaly degree.

The detection apparatus 200 can calculate an anomaly degree using a learned model having learned in advance. For example, the detection apparatus 200 acquires a feature vector in response to inputting time-series log data and time-series numerical data into the learned model. Then, the detection apparatus 200 calculates an anomaly degree using the acquired feature vector. As an example, the detection apparatus 200 may calculate an anomaly degree in response to calculating the distance between the origin, which is the center of the range of the planar space, and the feature vector as described in Patent Literature 1. The detection apparatus 200 may calculate an anomaly degree based on the degree of discrepancy between a distribution learned at the time of learning and the feature vector, or may alternatively employ any other method to calculate an anomaly degree. The learning of the aforementioned model may be conducted by machine learning with time-series log data, time-series numerical data, and performance data indicating performance index measured on the target C, as described in Patent Literature 1. As an example, the detection apparatus 200 generates a feature vector that includes information representing the mutual directional dependency between time-series log data and time-series numerical data, using a time-series log vector obtained by transforming the time-series log data and a time-series numerical vector obtained by transforming the time-series numerical data. Further, the detection apparatus 200 generates a prediction value from the generated feature vector. At this time, the detection apparatus 200 can perform machine learning using the time-series log data, the time-series numerical data and the performance data in such a manner as to minimize the error between the prediction value and the performance data and also generate a feature vector to be a distribution satisfying a preset criterion.

As described above, the detection apparatus 200 may be configured to perform learning of a model that is different from the model disclosed in Patent Literature 1 and calculate an anomaly degree. For example, the detection apparatus 200 may be configured to calculate an anomaly degree in response to inputting time-series log data and time-series numerical data into a learned model that calculates a reconstruction error.

Further, the detection apparatus 200 can perform anomaly detection in accordance with the calculated anomaly degree. For example, the detection apparatus 200 performs anomaly detection when the calculated anomaly degree meets a predetermined condition such as being equal to or more than a predetermined value. In response to this, the detection apparatus 200 transmits a notification that an anomaly has been detected, to the calculation apparatus 300. Additionally, the detection apparatus 200 transmits, to the calculation apparatus 300, at least the time-series log data among the time-series log data and the time-series numerical data when the anomaly has been detected, along with the notification that the anomaly has been detected. The transmission of the notification that the anomaly has been detected by the detection apparatus 200 may be carried out in response to an instruction from the calculation apparatus 300 or the like.

Further, as will be described later, the detection apparatus 200 may receive an instruction from the calculation apparatus 300 or the like to calculate an anomaly degree (an edition anomaly degree) using data edited by the calculation apparatus 300. In other words, the detection apparatus 200 may receive edition log data obtained by editing the time-series log data, from the calculation apparatus 300. In response to this, the detection apparatus 200 can calculate the edition anomaly degree in response to inputting data edited by the calculation apparatus 300 into a learned model in the same manner as when calculating the anomaly degree. That is to say, the detection apparatus 200 calculates the edition anomaly degree using the unedited time-series numerical data used when calculating the anomaly degree and the edition log data. Then, the detection apparatus 200 transmits the calculated edition anomaly degree to the calculation apparatus 300.

The calculation apparatus 300 is an information processing apparatus that calculates the contribution degree by using the time-series log data, time-series numerical data and so forth received from the detection apparatus 200. FIG. 3 shows a major configuration example of the calculation apparatus 300. Referring to FIG. 3, the calculation apparatus 300 has, as main components, an operation input unit 310, a screen display unit 320, a communication interface unit 330, a storage unit 340, and an arithmetic processing unit 350.

FIG. 3 illustrates a case of implementing a function as the calculation apparatus 300 by using a single information processing apparatus. However, at least part of the function as the calculation apparatus 300 may be implemented by using a plurality of information processing apparatuses, such as being implemented on the cloud, for example. Further, the calculation apparatus 300 may not include part of the configuration illustrated above, such as not having the operation input unit 310 or the screen display unit 320, or may have a configuration other than that illustrated above.

The operation input unit 310 is configured with an operation input device such as a keyboard and a mouse. The operation input unit 310 detects an operation by an operator who operates the calculation apparatus 300, and outputs it to the arithmetic processing unit 350.

The screen display unit 320 is configured with a screen display device such as a liquid crystal display or an organic EL (electro-luminescence). The screen display unit 320 can display on a screen a variety of information stored in the storage unit 340 in accordance with an instruction from the arithmetic processing unit 350.

The communication interface unit 330 is configured with a data communication circuit and the like. The communication interface unit 330 performs data communication with an external device connected via a communication line.

The storage unit 340 is a storage device such as a hard disk or memory. The storage unit 340 stores processing information and a program 343 necessary for various processing by the arithmetic processing unit 350. The program 343 enables various processing units by being loaded and executed by the arithmetic processing unit 350. The program 343 is loaded in advance from an external device or a recording medium via a data input/output function such as the communication interface unit 330, and stored in the storage unit 340. Main information stored in the storage unit 340 includes, for example, data information 341, anomaly degree information 342, and the like.

The data information 341 includes various data such as time-series log data and time-series numerical data used by the detection apparatus 200 when detecting an anomaly. In other words, the data information 341 includes the log data, the numerical data and the like within the time width corresponding to anomaly detection. In the time-series log data, the time-series numerical data and the like, information indicating time when the log data, the numerical data and the like have been acquired on the target C or the like may be associated with the log data, the numerical data and the like. Further, the log data may be a value obtained by transforming into an embedded vector in accordance with the type of the corresponding event. The data information 341 can be updated in response to, for example, acquisition of the time-series log data and the time-series numerical data from the detection apparatus 200 by the acquiring unit 351.

The data information 341 may include data edited through an edition process to be described later, in addition to the time-series log data and time-series numerical data described above. In other words, the data information 341 may be updated in accordance with, for example, the result of edition by the edition anomaly degree acquiring unit 353.

The anomaly degree information 342 includes information indicating the anomaly degree at the time when the detection apparatus 200 has detected the anomaly. In other words, the anomaly degree information 342 includes information indicating the anomaly degree calculated using the time-series log data, the time-series numerical data and the like included in the data information 341. The anomaly degree information 342 can be updated in response to, for example, acquisition of the anomaly degree from the detection apparatus 200 by the acquiring unit 351.

The anomaly degree information 342 may include an edition anomaly degree and the like as in the case of the data information 341. In other words, the data information 341 may be updated in accordance with the result of the edition anomaly degree acquisition by the edition anomaly degree acquiring unit 353, or the like.

The arithmetic processing unit 350 has an arithmetic logic unit such as a CPU and a peripheral circuit thereof. The arithmetic processing unit 350 reads the program 343 from the storage unit 340 and executes it, thereby making the above hardware and the program 343 cooperate and implementing various processing units. Main processing units implemented by the arithmetic processing unit 350 are, for example, an acquiring unit 351, an edition candidate extracting unit 352, an edition anomaly degree acquiring unit 353, a contribution degree calculating unit 354, and an output unit 355.

The arithmetic processing unit 350 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The acquiring unit 351 (a calculation result acquiring unit) acquires various data such as time-series log data and time-series numerical data used at the time of anomaly detection, a calculated anomaly degree, and any other information, from the detection apparatus 200. Moreover, the acquiring unit 351 stores the acquired time-series log data, time-series numerical data and so forth into the data information 341 and also stores the acquired anomaly degree and so forth into the anomaly degree information 342. The acquiring unit 351 may acquire, instead of the log data, an embedded vector obtained by transforming the log data.

The edition candidate extracting unit 352 extracts edition candidate log data to be a candidate for edition among the log data included in the time-series log data. For example, the edition candidate extracting unit 352 can extract log data to be an edition candidate in accordance with the result of calculating the gradient of the anomaly degree using the log data.

For example, the edition candidate extracting unit 352 acquires, for each log data included in the time-series log data, an embedded vector obtained by transforming the log data in accordance with the event type or the like. Further, the edition candidate extracting unit 352 calculates the gradient of the anomaly degree with respect to the embedded vector by performing differentiation or the like. Then, the edition candidate extracting unit 352 extracts log data to be an edition candidate based on the norm of the calculated gradient. As an example, as shown in FIG. 4, the edition candidate extracting unit 352 extracts a predetermined number of log data in descending order of the norms of the gradients, as edition candidate log data. For example, the edition candidate extracting unit 352 may extract log data to be an edition candidate based on the L2 norm or the like.

The edition anomaly degree acquiring unit 353 acquires an edition anomaly degree, which is an anomaly degree at the time of edition, by using the time-series numerical data and the edition log data obtained by editing part of the log data included in the time-series log data. The edition anomaly degree acquiring unit 353 can acquire the edition anomaly degree from the detection apparatus 200 in response to, for example, transmitting the edition log data to the detection apparatus 200.

FIG. 5 shows an example of an edition anomaly degree acquisition process by the edition anomaly degree acquiring unit 353. Referring to FIG. 5, the edition anomaly degree acquiring unit 353 acquires the edition anomaly degree by using edition log data obtained by deleting one log data among the log data to be edition candidates. Moreover, the edition anomaly degree acquiring unit 353 acquires the edition anomaly degree while changing the log data to be deleted. Accordingly, the edition anomaly degree acquiring unit 353 performs acquisition of the edition anomaly degree at the time when one of the extracted edition candidate log data is deleted, for each edition candidate log data. For example, in a case where the edition candidate extracting unit 352 extracts α pieces of edition candidate log data, the edition anomaly degree acquiring unit 353 can acquire α edition anomaly degrees.

The edition anomaly degree acquiring unit 353 may perform acquisition of the edition anomaly degree at the time when multiple pieces of log data gathered in accordance with any condition or the like. That is to say, the edition anomaly degree acquiring unit 353 may perform acquisition of the edition anomaly degree by editing any number of two or more of log data that are part of the log data included in the time-series log data. Further, the edition anomaly degree acquiring unit 353 may be configured to replace the log data, instead of deleting. For example, the edition anomaly degree acquiring unit 353 may acquire the edition anomaly degree after replacing one log data among the edition candidate log data with any of the other log data included in the time-series log data. Thus, the edition anomaly degree acquiring unit 353 may perform replacement or the like instead of deletion as the edition process.

The contribution degree calculating unit 354 calculates a contribution degree, which is a score indicating an extent to which an event corresponding to edited log data has contributed to an anomaly, using an anomaly degree and an edition anomaly degree. That is to say, the contribution degree calculating unit 354 calculates a contribution degree to log data, which is text data, using an anomaly degree and an edition anomaly degree.

For example, the contribution degree calculating unit 354 calculates the contribution degree by performing a subtraction process of subtracting the edition anomaly degree from the anomaly degree. As described above, the edition anomaly degree acquiring unit 353 acquires edition anomaly degrees corresponding to the number of log data to be edition candidates. Therefore, the contribution degree calculating unit 354 can calculate contribution degrees corresponding to the number of log data to be edition candidates by performing the abovementioned subtraction process on each of the edition anomaly degrees.

The contribution degree calculating unit 354 may be configured to calculate the contribution degree to the log data that is text data using the method as described above, and also calculate the contribution degree to the numerical data. For example, the contribution degree calculating unit 354 can calculate the contribution degree to the numerical data by any method while fixing the text data. As an example, the contribution degree calculating unit 354 may calculate the contribution degree to the numerical data by a known method as described in Patent Literature 2. Further, in a case where a model that calculates a reconstruction error is used as a model in calculating an anomaly degree, the contribution degree calculating unit 354 can acquire the contribution degree to each numerical data in accordance with, for example, acquiring a reconstruction error for each data item from the detection apparatus 200. As an example, the contribution degree calculating unit 354 may acquire a reconstruction error for each data item as the contribution degree.

The output unit 355 outputs the contribution degree calculated by the contribution degree calculating unit 354, and so forth. The output unit 355 may output information indicating the edition anomaly degree used in calculation of the contribution degree, the log data used in calculation of the edition anomaly degree, an event corresponding to the log data, and so forth, together with the contribution degree. The output unit 355 may display the contribution degree and so forth on the screen display unit 320, or transmit to an external device via the communication interface unit 330.

The output unit 355 may be configured to output, in addition to the contribution degree illustrated above, information on the presence or absence of anomaly detection, the anomaly degree and edition candidates, and any other information.

The above is a configuration example of the output unit 355. Subsequently, an operation example of the calculation apparatus 300 will be described with reference to FIG. 6. The operation in FIG. 6 may be started at any timing, such as when the acquiring unit 351 acquires time-series log data.

FIG. 6 is a flowchart showing an operation example of the calculation device 300. Referring to FIG. 6, for example, the edition candidate extracting unit 352 acquires an embedded vector obtained by transforming log data in accordance with the event type or the like. Further, the edition candidate extracting unit 352 calculates the gradient of the anomaly degree with respect to the embedded vector by performing differentiation or the like (step S101).

The edition candidate extracting unit 352 extracts log data to be an edition candidate based on the norm of the calculated gradient (step S102). As an example, the edition candidate extracting unit 352 extracts a predetermined number of log data in descending order of the norms of the gradients as edition candidate log data.

The edition anomaly degree acquiring unit 353 acquires an edition anomaly degree, which is an anomaly degree at the time of edition, by using the time-series numerical data and the edition log data obtained by editing part of the log data included in the time-series log data. For example, the edition anomaly degree acquiring unit 353 acquires the edition anomaly degree using edition log data obtained by deleting one log data among the edition candidate log data (step S103). Further, in a case where log data having not been subjected to edition such as deletion is left among the edition candidate log data (step S104, YES), the edition anomaly degree acquiring unit 353 acquires the edition anomaly degree by using edition log data obtained by deleting one log data among unedited, edition candidate log data (step S103).

In a case where the edition anomaly degree is acquired by performing edition on each edition candidate log data (step S104, No), the contribution degree calculating unit 354 calculates a contribution degree indicating an extent to which an event corresponding to the edited log data has contributed to the anomaly, using the anomaly degree and the edition anomaly degree (step S105). The contribution degree calculating unit 354 can calculate the contribution degrees corresponding to the number of edition candidate log data.

The output unit 355 outputs the contribution degree calculated by the contribution degree calculating unit 354, and so forth (step S106). The output unit 355 may display the contribution degree and so forth on the screen display unit 320, or transmit to an external device via the communication interface unit 330.

The above is an operation example of the calculation apparatus 300. FIG. 6 shows an operation example of the calculation apparatus 300, and the operation of the calculation apparatus 300 is not limited to the case illustrated in FIG. 6. For example, the contribution degree may be calculated every time the edition anomaly degree is acquired. In addition, any modified example may be adopted.

Thus, the calculation apparatus 300 includes the edition anomaly degree acquiring unit 353 and the contribution degree calculating unit 354. According to such a configuration, the contribution degree calculating unit 354 can calculate the contribution degree using the edition anomaly degree acquired by the edition anomaly degree acquiring unit 353. Consequently, it is also possible to determine an extent to which the log data as text data has contributed to the anomaly. As a result, it is possible to appropriately identify data having contributed to the detection of the anomaly.

Further, the calculation apparatus 300 includes the edition candidate extracting unit 352. According to such a configuration, the edition anomaly degree acquiring unit 353 can acquire the edition anomaly degree by editing log data to be an edition candidate extracted by the edition candidate extracting unit 352. Consequently, it is possible to enable a more efficient contribution degree calculation process. As a result, it is possible to identify data having contributed to the detection of the anomaly more efficiently.

FIGS. 7 and 8 illustrate a contribution degree calculation example using the calculation apparatus 300. FIG. 7 shows an example of acquiring numerical data and log data that have a relation in which the value of the numerical data increases when an event of ID0 occurs. Referring to FIG. 7, in a time width surrounded by a frame in FIG. 7, there is no change in numerical value while the event of ID0 occurs. Therefore, it can be said that an anomaly has occurred in a site shown by the frame in FIG. 7.

FIG. 8 shows an example of a case where the contribution degree is actually calculated under such a situation. Referring to FIG. 8, it can be seen that a contribution degree based on an edition anomaly degree acquired by editing log data corresponding to the event 0 is the highest value. That is to say, it can be seen from FIG. 8 that the log data of the event 0 is highly possible to contribute to the anomaly. In the case of the example as shown in FIG. 7, even when a contribution degree of numerical data alone is calculated using the method as described in Patent Literature 2, it is difficult to appropriately identify data having contributed to the detection of the anomaly. Referring to FIGS. 7 and 8, it can be seen that it is possible to appropriately identify data having contributed to the detection of an anomaly at the time of detecting an anomaly in an information processing system, a plant and the like by using the method described in the present disclosure. In other words, according to the calculation system 100 illustrated in the present disclosure, even in a case such that an anomaly cannot be discriminated based on numerical data alone in an information processing system or the like that is capable of acquiring both numerical data and log data, it is possible to appropriately identify data having contributed to the detection of an anomaly.

The configuration of the calculation apparatus 300 is not limited to the case illustrated in the present disclosure. For example, the calculation apparatus 300 may not have the edition candidate extracting unit 352 and so forth. In a case where the calculation apparatus 300 does not have the edition candidate extracting unit 352, the edition anomaly degree acquiring unit 353 may acquire the edition anomaly degree by editing each log data included in the time-series log data, for example.

Further, in the present disclosure, the contribution degree calculating unit 354 may be configured to calculate a contribution degree with respect to log data that is text data, and also calculate a contribution degree with respect to numerical data by an existing method as described in Patent Literature 2. However, the contribution degree calculating unit 354 may calculate a contribution degree with respect to numerical data by a method to be described later related to the method for calculating the contribution degree with respect to the text data illustrated in the present disclosure. For example, the contribution degree calculating unit 354 can perform calculation of a contribution degree with respect to numerical data using a method to be described later in such a case of calculating an anomaly degree using a model other than a model calculating a reconstruction error.

As an example, the contribution degree calculating unit 354 can perform the following process, while fixing log data that is text data. For example, the contribution degree calculating unit 354 calculates the gradient of an anomaly degree with respect to input numerical data. Then, the contribution degree calculating unit 354 generates numerical data that lowers the anomaly degree by using the probability gradient descent method or the like. For example, the contribution degree calculating unit 354 repeats the generating step as described above a predetermined number of times or until the anomaly value falls below a predetermined value. After that, the contribution degree calculating unit 354 calculates a contribution degree in response to, for example, calculating the difference between the finally generated numerical data and the original numerical data for each data item. As an example, the contribution degree calculating unit 354 may calculate the squared error (mean squared error when there are multiple types of numerical data) or the like, as an index of the difference.

For example, as described above, the contribution degree calculating unit 354 may calculate a contribution degree by editing numerical data in such a case of calculating an anomaly degree using a model other than a model that calculates a reconstruction error.

Further, as described above, the detection apparatus 200 and the calculation apparatus 300 may be configured with a single information processing apparatus or the like. In this case, the calculation apparatus 300 has a previously learned model, and can thereby perform calculation of an anomaly degree, detection of an anomaly using the calculated anomaly degree, and so forth. Likewise, the calculation apparatus 300 can calculate an edition anomaly degree.

Further, the calculation apparatus 300 may have a configuration other than the configuration illustrated in FIG. 3. For example, FIG. 9 shows a modified example of the calculation apparatus 300. Referring to FIG. 9, the arithmetic processing unit 350 of the calculation apparatus 300 can implement a control unit 356 or the like in addition to the configuration illustrated in FIG. 3 by loading and executing the program 343.

The control unit 356 performs a predetermined control on the target C or the like based on the contribution degree calculated by the contribution degree calculating unit 354.

For example, the control unit 356 identifies an event that is highly possible to contribute to an anomaly based on the contribution degree calculated by the contribution degree calculating unit 354. As an example, the control unit 356 identifies an event corresponding to a contribution degree with the highest value as an event that is highly possible to contribute to the anomaly. The control unit 356 may identify one or a plurality of events in accordance with a condition other than that illustrated above.

Further, the control unit 356 can perform a predetermined control on a target corresponding to the identified event or the like. For example, the control unit 356 can, in accordance with the identified event, perform restart, call a predetermined person such as an engineer, or perform any other control. As an example, the control unit 356 stores in advance, for each event, information such as a control content such as restart and a control target corresponding to the event. By checking the above information, the control unit 356 can perform control according to the event on the target according to the identified event. The information may include information indicating a control content corresponding to an event or the value of the contribution degree. Moreover, the control unit 356 may perform processing other than those illustrated above, such as identifying a control content to be executed in response to inputting the contribution degree and information indicating the identified event into a previously learned model or the like.

### Second Example Embodiment

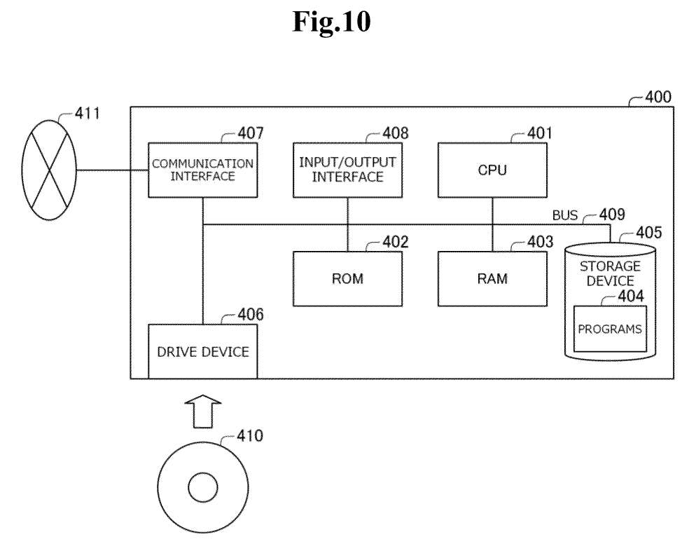

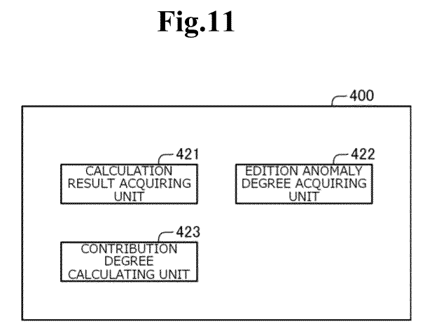

Subsequently, a calculation apparatus 400, which is a modified example of the calculation apparatus 300, will be described with reference to FIGS. 10 and 11. FIG. 10 is a diagram illustrating an example of a hardware configuration of the calculation apparatus 400. FIG. 11 is a block diagram showing an example of a configuration of the calculation apparatus 400.

The calculation apparatus 400 is an information processing apparatus that at least calculates, in accordance with the result of calculation of an anomaly degree using log data and numerical data, a contribution degree indicating an extent to which an event corresponding to the log data has contributed to an anomaly. FIG. 10 shows an example of a configuration of the calculation apparatus 400. Referring to FIG. 10, the calculation apparatus 400 has, as an example, the following hardware configuration including:

a CPU (Central Processing Unit) 401 (arithmetic logic unit);

a ROM (Read Only Memory) 402 (memory unit);

a RAM (Random Access Memory) 403 (memory unit);

programs 404 loaded into the RAM 403; a storage device 405 storing the programs 404;

a drive device 406 that performs reading from and writing into a recording medium 410 external to the information processing apparatus;

a communication interface 407 connected to a communication network 411 external to the information processing apparatus;

an input/output interface 408 that performs input/output of data; and

a bus 409 connecting the components.

Further, the calculation apparatus 400 can implement functions as a calculation result acquiring unit 421, an edition anomaly degree acquiring unit 422 and a contribution degree calculating unit 423 shown in FIG. 11, by acquisition and execution of the programs 404 by the CPU 401. The programs 404 are, for example, stored in advance in the storage device 405 or the ROM 402, and are loaded into the RAM 403 or the like and executed by the CPU 401 as necessary. Moreover, the programs 404 may be provided to the CPU 401 via the communication network 411, or the programs may be stored in advance in the recording medium 410 and read out by the drive device 406 and provided to the CPU 401.

FIG. 10 shows an example of the hardware configuration of the calculation apparatus 400. The hardware configuration of the calculation apparatus 400 is not limited to the abovementioned case. For example, the calculation apparatus 400 may be configured with part of the abovementioned configuration, such as not having the drive device 406. Moreover, the CPU 401 may be a GPU or the like illustrated in the first example embodiment.

The calculation result acquiring unit 421 acquires the result of calculation of an anomaly degree using time-series log data including log data corresponding to each event having occurred in a target within a predetermined time width, and time-series numerical data representing a measurement value corresponding to the predetermined time width among time-series measurement values that can be acquired by measuring the target. For example, the calculation result acquiring unit 421 may acquire, along with the calculated anomaly degree, at least the time-series log data of the time-series log data and the time-series numerical data used in calculation of the anomaly degree.

The edition anomaly degree acquiring unit 422 acquires an edition anomaly degree, which is an anomaly degree in edition, by using the time-series numerical data at the time of calculating the acquired anomaly degree and edition log data obtained by editing part of the log data included in the time-series log data.

The contribution degree calculating unit 423 calculates a contribution degree indicating an extent to which the event corresponding to the edited log data has contributed to the anomaly, using the anomaly degree and the edition anomaly degree. For example, the contribution degree calculating unit 423 may calculate a contribution degree by performing a subtraction process of subtracting an edition anomaly degree from an anomaly degree.

Thus, the calculation apparatus 400 includes the edition anomaly degree acquiring unit 422 and the contribution degree calculating unit 423. According to such a configuration, the contribution degree calculating unit 423 can calculate a contribution degree indicating an extent to which an event corresponding to edited log data has contributed to an anomaly, by using an edition anomaly degree. Consequently, it is also possible to determine an extent of contribution to the anomaly with respect to the log data that is text data. As a result, it is possible to more appropriately identify data having contributed to the detection of an anomaly.

The calculation apparatus 400 described above can be enabled by incorporating a predetermined program into an information processing apparatus such as the calculation apparatus 400. To be specific, a program as another aspect of the present disclosure is a program for causing the information processing apparatus such as the calculation apparatus 400 to execute processes to: acquire the result of calculation of an anomaly degree using time-series log data including log data corresponding to each event having occurred in a target within a predetermined time width and time-series numerical data representing a measurement value corresponding to the predetermined time width among time-series measurement values that can be acquired by measuring the target; acquire an edition anomaly degree, which is an anomaly degree at the time of edition, by using the time-series numerical data at the time of calculating the acquired anomaly degree and edition log data obtained by editing part of the log data included in the time-series log data; and calculate a contribution degree indicating an extent to which the event corresponding to the edited log data has contributed to the anomaly, by using the anomaly degree and the edition anomaly degree.

Further, a calculation method executed by the information processing apparatus such as the calculation apparatus 400 described above is a method in which the information processing apparatus such as the calculation apparatus 400 acquires the result of calculation of an abnormal degree using time-series log data including log data corresponding to each event having occurred in a target within a predetermined time width, and time-series numerical data representing a measurement value corresponding to the predetermined time width among time-series measurement values that can be acquired by measuring the target, and acquires an edition anomaly degree, which is an anomaly degree at the time of edition, by using the time-series numerical data at the time of calculation of the acquired anomaly degree and edition log data obtained by editing part of the log data included in the time-series log data, and calculates a contribution degree indicating an extent to which the event corresponding to the edited log data contributes to the anomaly, by using the anomaly degree and the edition anomaly degree.

Since the program, computer-readable recording medium with the program recorded, calculation method or the like having the above configurations exert the same actions and effects as the calculation apparatus 400 described above, the aforementioned object of the present disclosure can be achieved.

### Supplementary Notes

The whole or part of the example embodiments disclosed above can be described as the following supplementary notes. Hereinafter, the overview of a calculation apparatus and so forth in the present disclosure will be described. However, the present disclosure is not limited to the following configurations.

### Supplementary Note 1

A calculation apparatus comprising:

a calculation result acquiring unit configured to acquire a result of calculation of an anomaly degree using time-series log data including log data within a predetermined time width and time-series numerical data representing measurement values within the predetermined time width;

an edition anomaly degree acquiring unit configured to acquire an edition anomaly degree, which is an anomaly degree at time of editing, by using the time-series numerical data at time of calculating the anomaly degree and edition log data obtained by editing part of the log data included by the time-series log data; and

a contribution degree calculating unit configured to calculate a contribution degree indicating an extent to which an event corresponding to the edited log data has contributed to an anomaly by using the anomaly degree and the edition anomaly degree.

### Supplementary Note 2

The calculation apparatus according to supplementary note 1, comprising an extracting unit configured to extract the log data to be edition candidates from among the log data included by the time-series log data, wherein

the edition anomaly degree acquiring unit is configured to perform a process of acquiring the edition anomaly degree using the edition log data obtained by editing one of the log data to be edition candidates, for each of the extracted log data to be edition candidates.

### Supplementary Note 3

The calculation apparatus according to supplementary note 1 or 2, wherein

the edition anomaly degree acquiring unit is configured to acquire the edition anomaly degree by using the edition log data obtained by deleting part of the log data included by the time-series log data.

### Supplementary Note 4

The calculation apparatus according to any one of supplementary notes 1 to 3, wherein

the edition anomaly degree acquiring unit is configured to calculate the edition anomaly degree by using the edition log data obtained by replacing part of the log data included by the time-series log data into other log data included by the time-series log data.

### Supplementary Note 5

The calculation apparatus according to any one of supplementary notes 1 to 4, comprising

a control unit configured to perform a given control determined in advance on a target identified in accordance with the calculated contribution degree.

### Supplementary Note 6

The calculation apparatus according to supplementary note 2, wherein

the extracting unit is configured to extract the log data to be edition candidates in accordance with a result of calculation of a gradient of the anomaly degree.

### Supplementary Note 7

The calculation apparatus according to supplementary note 2, wherein

the extracting unit is configured to extract the log data to be edition candidates based on a gradient norm of the anomaly degree with respect to an embedded vector obtained by transforming the log data.

### Supplementary Note 8

The calculation apparatus according to any of supplementary notes 1 to 7, wherein

the contribution degree calculating unit is configured to calculate a contribution degree indicating an extent to which the log data edited by using the anomaly degree and the edition anomaly degree has contributed to an anomaly, and calculate a contribution degree in the time-series numerical data by using data generated in such a manner as to decrease the anomaly degree based on a gradient of the anomaly degree and the time-series numerical data at time of calculating the anomaly degree.

### Supplementary Note 9

A calculation method by an information processing apparatus, the calculation method comprising:

acquiring a result of calculation of an anomaly degree using time-series log data including log data within a predetermined time width and time-series numerical data representing measurement values within the predetermined time width;

acquiring an edition anomaly degree, which is an anomaly degree at time of editing, by using the time-series numerical data at time of calculating the anomaly degree and edition log data obtained by editing part of the log data included by the time-series log data; and

calculating a contribution degree indicating an extent to which an event corresponding to the edited log data has contributed to an anomaly by using the anomaly degree and the edition anomaly degree.

### Supplementary Note 10

A program comprising instructions for causing an information processing apparatus to enable processes to:

acquire a result of calculation of an anomaly degree using time-series log data including log data within a predetermined time width and time-series numerical data representing measurement values within the predetermined time width;

acquire an edition anomaly degree, which is an anomaly degree at time of editing, by using the time-series numerical data at time of calculating the anomaly degree and edition log data obtained by editing part of the log data included by the time-series log data; and

calculate a contribution degree indicating an extent to which an event corresponding to the edited log data has contributed to an anomaly by using the anomaly degree and the edition anomaly degree.

All or some of the configurations described in Supplementary Notes 2 to 8 dependent on the calculation apparatus described in Supplementary Note 1 may be dependent on the calculation method described in Supplementary Note 9 and the program described in Supplementary Note 10 by the same dependence. Furthermore, not limited to Supplementary Notes 9 and 10, within the scope of the example embodiment described above, some or all of the configurations described as supplementary notes may be dependent on various hardware, software, various recording means for recording software, methods, programs, or systems.

The program described in the above example embodiments and supplementary notes can be stored using various types of non-transitory computer-readable mediums and provided to a computer. The non-transitory computer-readable medium includes various types of tangible storage mediums. Examples of the non-transitory computer-readable medium include a magnetic recording medium (e.g., flexible disk, magnetic tape, hard disk drive), a magneto-optical recording medium (e.g., magneto-optical disk), a CD-ROM (Read Only Memory), a CD-R, a CD-R/W, and a semiconductor memory (e.g., mask ROM, PROM (Programmable ROM), EPROM (Erasable PROM), flash ROM, RAM (Random Access Memory). In addition, the program may be provided to a computer by various types of transitory computer-readable mediums. Examples of the temporary computer-readable medium include electrical signals, optical signals, and electromagnetic waves. The transitory computer-readable medium can provide the program to the computer via a wired communication channel such as an electric wire and an optical fiber, or via a wireless communication channel.

Although the present disclosure has been described above with reference to the example embodiments described above, the present disclosure is not limited to the example embodiments described above. The configuration and details of the present disclosure can be changed in a variety of ways that those skilled in the art can understand within the scope of the present disclosure. Then, each of the example embodiments can be combined with the other example embodiment as necessary.

### REFERENCE SIGNS LIST

100 CALCULATION SYSTEM

200 detection apparatus

300 calculation apparatus

310 operation input unit

320 screen display unit

330 communication interface unit

340 storage unit

341 data information

342 anomaly degree information

343 program

350 arithmetic processing unit

351 acquiring unit

352 edition candidate extracting unit

353 edition anomaly degree acquiring unit

354 contribution degree calculating unit

355 output unit

356 control unit

400 calculation apparatus

401 CPU

402 ROM

403 RAM

404 programs

405 storage device

406 drive device

407 communication interface

408 input/output interface

409 bus

410 recording medium

411 communication network

421 calculation result acquiring unit

422 edition anomaly degree acquiring unit

423 contribution degree calculating unit

1. A calculation apparatus comprising:
at least one memory storing processing instructions; and
at least one processor configured to execute the processing instructions to:
acquire a result of calculation of an anomaly degree using time-series log data including log data within a predetermined time width and time-series numerical data representing measurement values within the predetermined time width;
acquire an edition anomaly degree, which is an anomaly degree at time of editing, by using the time-series numerical data at time of calculating the anomaly degree and edition log data obtained by editing part of the log data included by the time-series log data; and
calculate a contribution degree indicating an extent to which an event corresponding to the edited log data has contributed to an anomaly by using the anomaly degree and the edition anomaly degree.

2. The calculation apparatus according to claim 1, wherein the at least one processor is configured to execute the processing instructions to:
extract the log data to be edition candidates from among the log data included by the time-series log data; and
perform a process of acquiring the edition anomaly degree using the edition log data obtained by editing one of the log data to be edition candidates, for each of the extracted log data to be edition candidates.

3. The calculation apparatus according to claim 1, wherein the at least one processor is configured to execute the processing instructions to
acquire the edition anomaly degree by using the edition log data obtained by deleting part of the log data included by the time-series log data.

4. The calculation apparatus according to claim 1, wherein the at least one processor is configured to execute the processing instructions to
calculate the edition anomaly degree by using the edition log data obtained by replacing part of the log data included by the time-series log data into other log data included by the time-series log data.

5. The calculation apparatus according to claim 1, wherein the at least one processor is configured to execute the processing instructions to
perform a given control determined in advance on a target identified in accordance with the calculated contribution degree.

6. The calculation apparatus according to claim 2, wherein the at least one processor is configured to execute the processing instructions to
extract the log data to be edition candidates in accordance with a result of calculation of a gradient of the anomaly degree.

7. The calculation apparatus according to claim 2, wherein the at least one processor is configured to execute the processing instructions to
extract the log data to be edition candidates based on a gradient norm of the anomaly degree with respect to an embedded vector obtained by transforming the log data.

8. The calculation apparatus according to claim 1, wherein the at least one processor is configured to execute the processing instructions to
calculate a contribution degree indicating an extent to which the log data edited by using the anomaly degree and the edition anomaly degree has contributed to an anomaly, and calculate a contribution degree in the time-series numerical data by using data generated in such a manner as to decrease the anomaly degree based on a gradient of the anomaly degree and the time-series numerical data at time of calculating the anomaly degree.

9. A calculation method by an information processing apparatus, the calculation method comprising:
acquiring a result of calculation of an anomaly degree using time-series log data including log data within a predetermined time width and time-series numerical data representing measurement values within the predetermined time width;
acquiring an edition anomaly degree, which is an anomaly degree at time of editing, by using the time-series numerical data at time of calculating the anomaly degree and edition log data obtained by editing part of the log data included by the time-series log data; and
calculating a contribution degree indicating an extent to which an event corresponding to the edited log data has contributed to an anomaly by using the anomaly degree and the edition anomaly degree.

10. A non-transitory computer-readable recording medium with a program recorded thereon, the program comprising instructions for causing an information processing apparatus to enable processes to:
acquire a result of calculation of an anomaly degree using time-series log data including log data within a predetermined time width and time-series numerical data representing measurement values within the predetermined time width;
acquire an edition anomaly degree, which is an anomaly degree at time of editing, by using the time-series numerical data at time of calculating the anomaly degree and edition log data obtained by editing part of the log data included by the time-series log data; and
calculate a contribution degree indicating an extent to which an event corresponding to the edited log data has contributed to an anomaly by using the anomaly degree and the edition anomaly degree.
